(19) United States
(12) Patent Application Publication
(10) Pub. No.: US 2006/0220487 A1
(43) Pub. Date: Oct. 5, 2006

(54) Field apparatus for a rotary electric machine and field coil used for the field apparatus

(75) Inventor: Yamato Utsunomiya, Kariya-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/390,184

(22) Filed: Mar. 28, 2006

(30) Foreign Application Priority Data
Mar. 31, 2005 (JP) 2005-102122

(51) Int. Cl. H02K 3/00; H02K 23/02; H02K 3/04; H02K 1/12

(52) U.S. Cl. 310/179; 310/208; 310/254; 310/184

(57) ABSTRACT

A field apparatus has a tubular yoke and a field coil formed in a tubular shape and disposed on and fixed to an inner surface of the yoke. The field coil has a plurality of coil units disposed in parallel to each other along a circumferential direction of the yoke. The field coil further has a connecting conductor connecting free terminals of coil conductors of each pair of coil units to form a current path in the field coil. Each connecting conductor is curved along the circumferential direction of the yoke by bending the connecting conductor, and stiffness of the connecting conductor is lower than that of the coil conductor.

### CROSS-REFERENCE TO RELATED APPLICATION

This application is based upon and claims the benefit of priority of the prior Japanese Patent Application 2005-102122 field on Mar. 31, 2005 so that the contents of which are incorporated herein by reference.

### BACKGROUND OF THE INVENTION

1. Field of the Invention

The present invention generally relates to a field apparatus used for a rotary electric machine such as a starter of a vehicle, and more particularly to a field apparatus wherein each pair of coils in a field coil are connected with each other through a connecting conductor. The present invention further relates to a field coil used for the field apparatus.

2. Description of Related Art

A conventional field apparatus for a starter of a vehicle is, for example, disclosed in Published Japanese Patent Second Publication No. H05-17778. This apparatus has a cylindrical yoke, a plurality of coils disposed on an inside surface of the yoke, a ring-shaped crossover line connecting terminals of each pair of coils, and a plurality of insulators insulating the crossover lines from the yoke. Each coil is made by winding up a conductor line in a coil. The crossover line is made of a connecting conductor having almost the same diameter (or shape in section) and stiffness as those of the coil conductor lines. The insulators are disposed outside the crossover lines along a circumferential direction of the yoke. In the manufacturing of the apparatus, a cylindrical field coil having coils and crossover lines is inserted with insulators into an inside space of a yoke. Then, portions of the crossover lines not attached to any insulator are deformed so as to be curved along a circumferential direction of the yoke. Therefore, the insulators disposed between the coils and the yoke are strongly pressed by the deforming force to the inner surface of the yoke and are tightly fixed to the yoke. Accordingly, the deformation of the crossover lines having the same stiffness as that of the coil conductor lines can prevent the insulators and crossover lines from being vibrated in response to movement of the yoke, and breakage in the connection points between the terminals of the coils and the crossover lines can be prevented.

However, because the insulators are fixed to the yoke by the deforming force given to the crossover lines of which the stiffness is almost the same as that of the coil conductor lines, processing for deforming the crossover lines by using a pressing unit is additionally required. Therefore, productivity of the apparatus is lowered, and the configuration of a manufacturing device for the apparatus is undesirably complicated. The complicated configuration brings low reliability in the manufacturing of the apparatus.

Further, a working place for manufacturing a cylindrical field coil usually differs from that for inserting the field coil into a cylindrical yoke to assemble a field apparatus. For example, in knock down manufacturing, a cylindrical field coil is transported to an assemble shop and is inserted into a yoke. However, because the cylindrical field coil having an opened inside space occupies a large space, it is disadvantageous to pack the field coil, and the cost of transporting the field coil is heightened.

To solve these problems, each of the field coils flatly developed is manufactured, and the field coils are stacked up and packed. Then, each developed field coil is transported to an assemble shop and is made round into a cylindrical shape. However, it is required that crossover lines having the same diameter and stiffness as those of conductors of coils are deformed or bent to round the developed field coil in a cylindrical shape. When the developed field coil is made round, the coils and portions of the crossover lines connected with the coils undesirably receive a bending force added to the crossover lines. In this case, the coils and/or the connecting points between the coils and crossover lines are sometimes distorted and/or broken. Further, to accurately shape the crossover lines after its bending operation, it is required to additionally deform portions of the ring-shaped crossover lines with a private device. Therefore, productivity and reliability for the apparatus are sometimes lowered.

### SUMMARY OF THE INVENTION

An object of the present invention is to provide, with due consideration to the drawbacks of the conventional field apparatus, a field apparatus manufactured in high productivity and reliability while suppressing vibration of a field coil. Further, the object is to provide a field coil used for the field apparatus.

According to a first aspect of this invention, the object is achieved by the provision of a field apparatus for a rotary electric machine, comprising a tubular yoke and a field coil formed in a tubular shape and disposed on and fixed to an inner surface of the yoke. The field coil has a plurality of coil units disposed in parallel to each other along a circumferential direction of the yoke. Each coil unit is made of a coil conductor. The field coil further has a connecting conductor connecting free terminals of the coil conductors of each pair of coil units to form a current path in the field coil. Each connecting conductor is curved along the circumferential direction of the yoke by bending the connecting conductor, and stiffness of the connecting conductor is lower than that of the coil conductor.

Because stiffness of each connecting conductor is lower than that of the coil conductors, the connecting conductor straightly extended to flatly develop a field coil can be easily bent. Therefore, when a field coil flatly developed is made round into a tubular shape, distortion generated in the coil units and breakage generated in connection points of the coil terminals can considerably be reduced. Further, each connecting conductor having lower stiffness can be thinned and lightened in weight. Therefore, even when the yoke is vibrated during the operation of the field apparatus, vibration of the field coil resonating with the vibrated yoke can be easily suppressed, and breakage of the field coil can be considerably reduced.

Accordingly, productivity and reliability in the field apparatus can be improved, and vibration of the field coil can be considerably reduced.

According to a second aspect of this invention, the object is achieved by the provision of a field coil having a plurality of coil units disposed in parallel to each other along a first direction. Each coil unit is made of a coil conductor wound up in a coil so as to be formed in a circular arc on a predetermined plane defined by the first direction and a second direction perpendicular to the first direction. The field coil further has a connecting conductor through which each pair of coil units are connected with each other. Each connecting conductor extends along the first direction and is bendable so as to form a combination of the coil units in a cylindrical shape, and stiffness of each connecting conductor is lower than that of the coil conductor.

Therefore, the field coil can be used for the field apparatus.

### BRIEF DESCRIPTION OF THE DRAWINGS

FIG. 1A is an upper plan view of a developed field coil according to a first embodiment of the present invention;

FIG. 1B is a front view of the developed field coil;

FIG. 2 is an upper plan view of the field coil formed in a cylindrical shape;

FIG. 3 is an upper plan view of a field apparatus having the cylindrical field coil inserted into a yoke according to the first embodiment;

FIG. 4 is a view showing distortion generated in a coil conductor with respect to a ratio in section modulus between the connecting conductor and coil conductor; and

FIG. 5 is a front view of a coupled coil of another field coil according to a second embodiment of the present invention.

### DETAILED DESCRIPTION OF THE PREFERRED EMBODIMENTS

Embodiments of the present invention will now be described with reference to the accompanying drawings.

### Embodiment 1

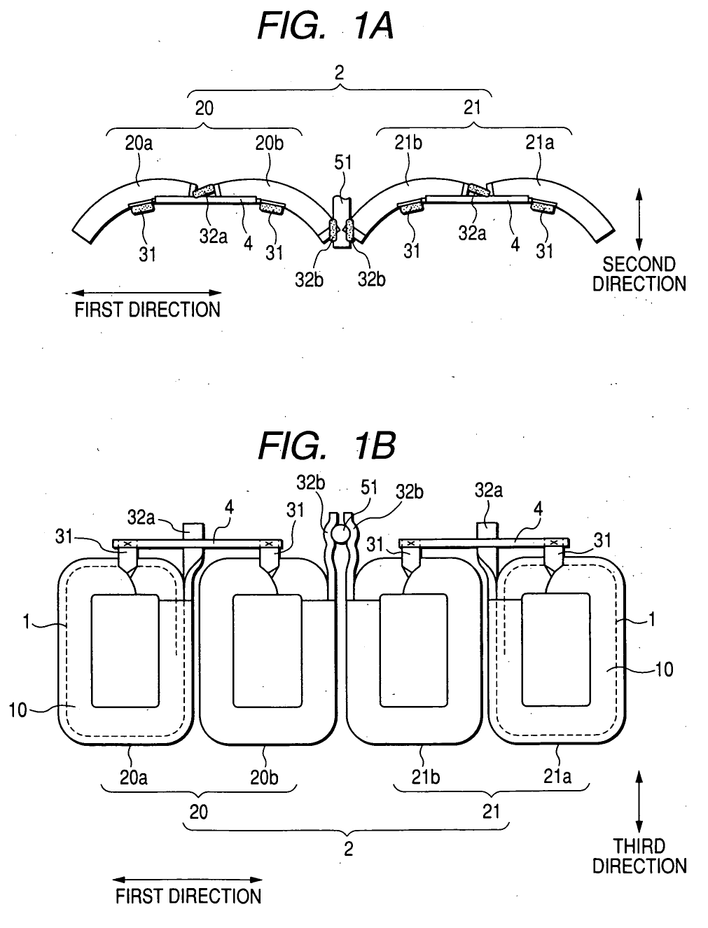

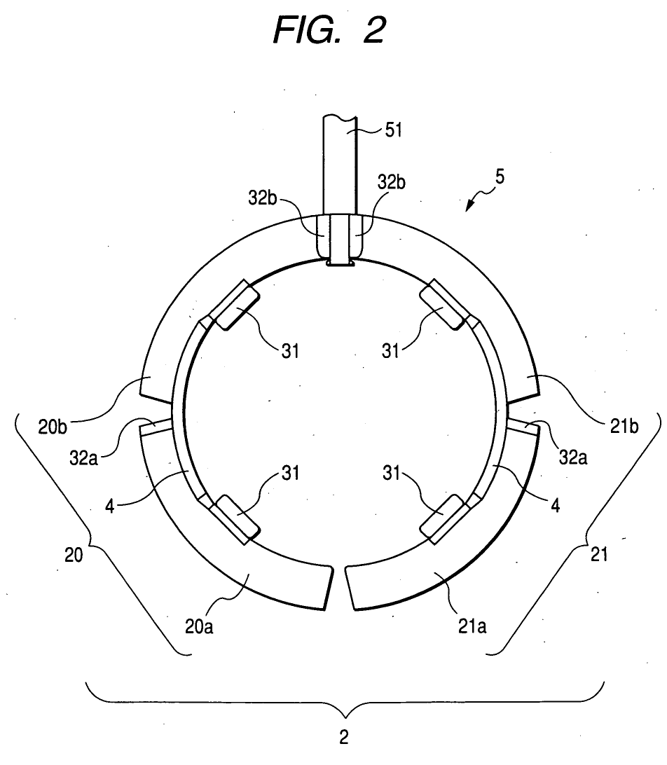

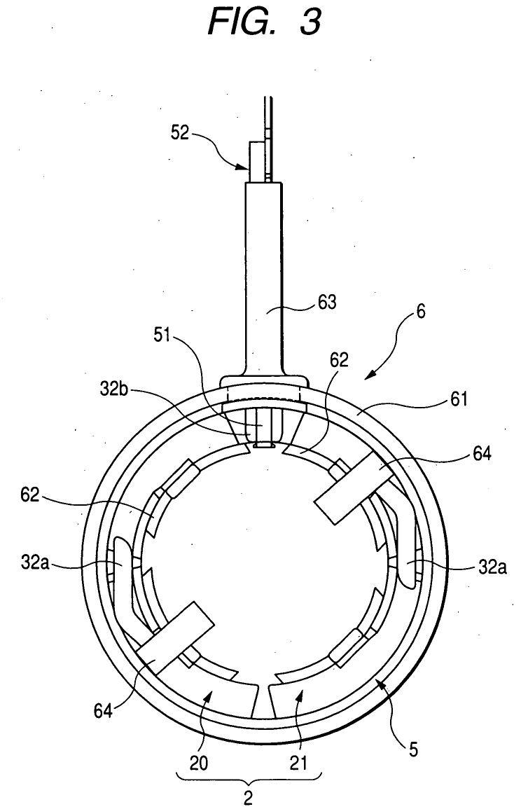

FIG. 1A is an upper plan view of a developed field coil according to a first embodiment, and FIG. 1B is a front view of the developed field coil. FIG. 2 is an upper plan view of the field coil formed in a cylindrical shape. FIG. 3 is an upper plan view of a field apparatus having the cylindrical field coil inserted into a yoke.

As shown in FIGS. 1A and 1B, a field coil 2 developed in a substantially flat-plate shape is initially manufactured. As shown in FIG. 2, the developed field coil 2 is made round into a cylindrical shape while bending connecting conductors 4 to obtain a cylindrical field coil 5. As shown in FIG. 3, the field coil 5 is inserted into a yoke 61 to assemble a field apparatus 6.

As shown in FIGS. 1A and 1B, the field coil 2 has two coupled coils 20 and 21. The coupled coil 20 has two coil units 20a and 20b. The coupled coil 21 has two coil units 21a and 21b. The coil units 20a, 20b, 21b and 21a are disposed in parallel to each other along a first direction in that order at predetermined intervals. Each coil unit is made by winding up a coil conductor 1 flatly in a coil such that each coil unit is curved substantially in a circular arc (quarter-circle) on a first plane defined by the first and second directions perpendicular to each other. Each conductor 1 is formed in a straight angle shape or a tape shape and is, for example, wound on a field core. Each coil unit has a coil surface 10 formed substantially in a rectangular shape on a second plane perpendicular to the first plane and defined by the first and third directions perpendicular to each other. Each long thinned coil conductor 1 has two wider surfaces and side surfaces and is covered with an electrical insulating tape or the like, but free terminals of the conductor 1 is not covered with any electrical insulator.

More specifically, each of the units 20a and 20b has the conductor 1 wounded counterclockwise, and each of the units 21a and 21b has the conductor 1 wounded clockwise. In each coil unit, a coil start terminal 31 (or free terminal) of the conductor 1 is protruded from an inside point of the coil unit and is extended upward along the third direction. In each of the coil units 20a and 21a, a coil end terminal 32a (or free terminal) of the conductor 1 is protruded from one side facing the adjacent coil unit 20b or 21b. In each of the coil units 20b and 21b, a coil end terminal 32b (or free terminal) of the conductor 1 is protruded from one side adjacent to the coil unit 21b or 20b. Each of the terminals 31 and 32a is twisted by almost 90 degrees so as to have a wider surface almost parallel to the coil surface 10.

The wider surfaces of the terminals 31 of the coil units 20a and 20b are tightly attached to a connecting conductor 4 by soldering, fusing or the like, so that the coil units 20a and 20b are electrically connected with each other to form a current path. In the same manner, the coil units 21a and 21b are electrically connected with each other through another connecting conductor 4 to form another current path. Therefore, each connecting conductor 4 acts as a crossover line for electrical conduction. The terminals 32b not twisted have wider surfaces facing each other, and the surfaces are substantially perpendicular to the coil surfaces 10. The terminals 32b are curved in a wave shape symmetrically to each other with respect to a center plane, which equally divides the field coil 2 into the coupling coils 20 and 21, to form a wide-width open space between the terminals 32b. A lead line 51 is held in this open space to electrically connect the coupled coils 20 and 21 with each other, so that the two current paths are combined by the lead line 51. The coupled coils 20 and 21 are configured to be symmetric to each other with respect to the center plane.

As shown in FIG. 1A, to make round the field coil 2 into a smoothed cylindrical shape matching with a shape of the inside surface of a yoke 61 (see FIG. 3), the coil units 20a to 21b formed in a circular arc on the second plane are curved in the same direction at a predetermined curvature. Each coil unit has the terminal 31 on its concave side (lower side in FIG. 1A), so that each connecting conductor 4 is placed on the concave side of the corresponding coil units. Each terminal 32a is placed on a convex side (upper side in FIG. 1A) of the corresponding coil unit with respect to the position of the connecting conductor 4. Therefore, when the field coil 2 is made round, the connecting conductors 4 do not come in contact with the terminals 32a.

Features of the connecting conductor are described. In a prior art, a crossover line has the same shape and stiffness as those of a conductor forming a coil. However, in this embodiment, each connecting conductor 4 is thinner than the coil conductor 1, and stiffness or rigidity of the connecting conductor 4 in the second direction is lower than that of the coil conductor 1. More specifically, a section modulus of the connecting conductor 4 in the second direction is equal to or less than one-fourth of a section modulus of the coil conductor 1. Preferably, a section modulus of the connecting conductor 4 in the second direction be equal to or less than one-fifth of a section modulus of the coil conductor 1. Therefore, when the connecting conductor 4 is bent to make round the field coil 2, the deforming force required to bend the connecting conductor 4 can be lowered. In addition, the thinned connecting conductor 4 can be lightened in weight.

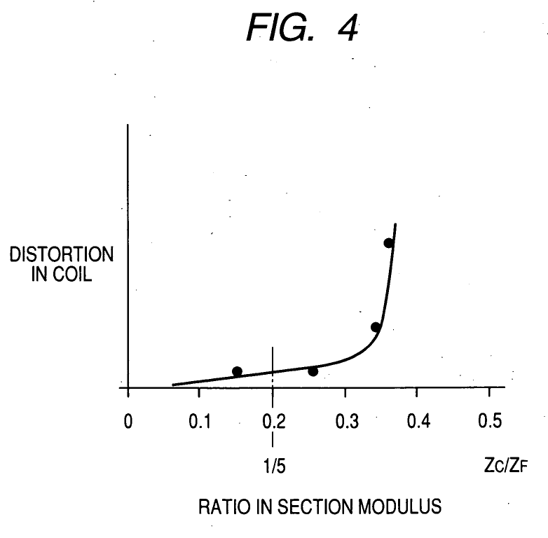

The inventors examined influence of the deforming force on the coil conductor 1 while changing a ratio Z_{C}/Z_{F} of a section modulus Z_{C} of the connecting conductor 4 to a section modulus Z_{F} of the coil conductor 1. A relationship between the ratio and distortion caused in the coil conductor 1 is shown in FIG. 4. As shown in FIG. 4, when the ratio Z_{C}/Z_{F} in the section modulus exceeds 1/3, the coil distortion is rapidly increased with the ratio Z_{C}/Z_{F}. When the ratio Z_{C}/Z_{F} is between 1/5 and 1/4, the coil distortion is low and is gradually increased with the ratio Z_{C}/Z_{F}. When the ratio Z_{C}/Z_{F} is 1/5 or below, the coil distortion is negligible. Therefore, when the ratio Z_{C}/Z_{F} is ranged from 1/5 to 1/4, the coil distortion generated by the deforming force is allowable to maintain the electric connection of the coil units. When the ratio Z_{C}/Z_{F} is 1/5 or less, the coil distortion is allowable to maintain the electric connection of the coil units with a sufficient margin.

As to material properties of the connecting conductor 4, the connecting conductor 4 is not limited to hard material, but any conductive material having bendable and light characteristics is usable for the connecting conductor 4. The connecting conductor 4 may be made of soft material, annealed material, or material having low specific gravity.

As to shape characteristics of the connecting conductor 4, in this embodiment, the connecting conductor 4 is made of a rod having a uniform thickness and a rectangular sectional area. However, the connecting conductor 4 may have thin portions and thick portions alternately arranged along its longitudinal direction (or first direction) to easily bend the connecting conductor 4 at the thin portion(s) by a sufficiently low bending force. The number of thin portions and the number of thick portions in the connecting conductor 4 are not restricted.

When the field coil 2 shown in FIG. 1A is made round such that a concave side of the coil units is placed inside the rounded coil 2, a cylindrical field coil 5 shown in FIG. 2 is obtained. Because the connecting conductors 4 are thinner than the coil conductors 1 such that stiffness of the connecting conductors 4 in a radial direction of the field coil 5 is lower than that of the coil conductors 1, the field coil 2 can easily be made round into a cylindrical shape by a small force. Because the connecting conductors 4 can be bent in the radial direction by a small force, no large bending force is added to the coil units 20a to 21b or the connection points between the connecting conductors and the coil units. Therefore, the combination of the four coil units each having a circular arc shape can be made round into a whole circular shape while suppressing the generation of distortion in the coil units. Further, because deformation of the coil units is suppressed, the circular arc shape of each coil unit can be maintained. Therefore, center points of the inner and outer circumferential surfaces of the field coil 5 coincide with each other.

As shown in FIG. 3, the field coil 5 is, for example, inserted into a cylindrical yoke 61 of a starting motor. The connecting conductors 4 are bent by a small force added to the conductors in a radial direction of the yoke 61 and are curved along a circumferential direction of the yoke 61. The connecting conductors 4 are placed on the inner side of the yoke 61 with respect to the coil units. Because the center positions of the inner and outer circumferential surfaces coincide with each other in the field coil 5, the field coil 5 can be smoothly attached to the cylindrical inner surface of the yoke 61. After the insertion of the field coil 5, pole cores 62 are attached to the inner surface of the coil 5, and the pole cores 62 are screwed to the yoke 61 by inserting screws (not shown) into holes disposed at portions of the pole cores 62 and the yoke 61 not contacting with the coil 5. Therefore, the coil 5 placed between the pole cores 62 and the yoke 61 can be tightly fixed to the inner surface of the yoke 61. Further, the lead line 51 held between the terminals 32b is protruded from the yoke 61 through an insulating bush 63 and acts as an anode line 52. A brush 64 is electrically connected with each terminal 32a disposed almost parallel to the coil surface 10.

When alternating current passes though the coil units 20a to 21b via the bushes 64 and anode line 52, each coil unit generates a magnetic field along a radial direction of the yoke 61. Assuming that an armature with a rotor (not shown) is disposed inside the field coil 5, each coil unit acts as a magnetic pole for the armature. Types of the magnetic poles adjacent to each other differ from each other. In this case, the rotor is rotated with the armature. That is, the field coil 5 inserted into the yoke 61 acts as a field apparatus 6.

Therefore, because each connecting conductor 4 having a section modulus smaller than that of the conductor 1 along the second direction connects the corresponding pair of terminals 31, the connecting conductor 4 can easily be bent by a small force without using a specific bending device to make round the field coil 2. Accordingly, distortion generated in the coil units can be considerably reduced, so that the field coil 2 can easily be made round into a desired cylindrical shape with high accuracy. That is, the field apparatus 6 having the field coil 5 attached to the yoke 61 can easily be obtained while leaving almost no space between the field coil 5 and the yoke 61.

Further, because each connecting conductor 4 can easily be bent by a small force, the field coil 2 can be made round at any time and place. For example, when a working place for producing a field coil differs from an assembling place for inserting the field coil into a cylindrical yoke, the field coil having coil units serially connected with each other and being formed in a substantially flat shape is transported and is made round in an assembling place. Accordingly, productivity of the field coil can be improved. Further, because the field coil is formed almost flatly and has no hollow space, field coils can be stacked up and densely packed. Therefore, a dead space in the transportation of the field coils 2 is small as compared with that in cylindrical field coils. Accordingly, cost for packing and transportation can be considerably lowered.

Moreover, because the connecting conductor 4 becomes thinned to lower its section modulus, the connecting conductor 4 becomes lightened in weight. Therefore, the whole field coil 5 can be lightened, and the weight of the field coil 5 vibrated with the yoke 61 becomes light. Accordingly, even when the yoke 61 is vibrated, vibration of the field coil 5 resonating with the vibrated yoke 61 can be easily suppressed, and breakage of the field coil 5 can be considerably reduced.

Furthermore, when a section modulus of the connecting conductor 4 in the second direction is equal to or less than one-fourth of a section modulus of the coil conductor 1, stiffness of the connecting conductor 4 can considerably become lower than that of the coil conductor 1. Therefore, the field coil 2 can further easily be made round, and distortion of the coil units and/or breakage of the connection points can further be reduced. Further, electric resistance of the connecting conductor 4 becomes considerably higher than that of the conductor 1, so that the connecting conductor 4 can easily be melt in response to a large current flowing through the connecting conductor 4 to disconnect the coil units from each other. Accordingly, the connecting conductor 4 can act as a fuse for preventing a large current flowing through the field coil 5.

### Embodiment 2

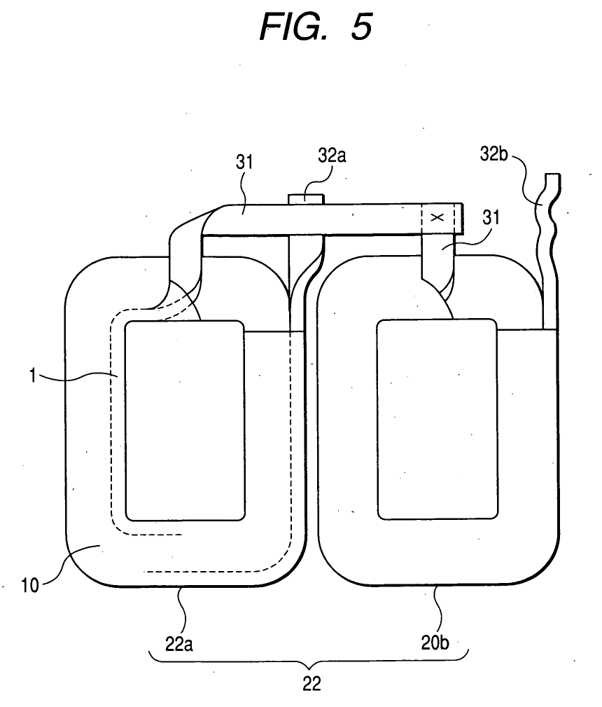

FIG. 5 is a front view of a coupled coil according to a second embodiment. A coupled coil 22 according to a second embodiment differs from the coupled coil 20 or 21 in that a coil start terminal 31 of a coil unit 22a having a coil conductor 1 wound counterclockwise is drawn from the coil unit 22a and is directly connected with the terminal 31 of the coil unit 20b disposed adjacent to the coil unit 22a without using any connecting conductor 4. Therefore, the terminal 31 of the coil unit 22a acts as a crossover line. More specifically, the terminal 31 protruded from the coil unit 22a by a predetermined length is twisted, bent and extended in the same manner as in the first embodiment. Then, the terminal 31 is twisted and bent by almost 90 degrees so as to have a wider surface almost parallel to a coil surface 10 of the unit and to be extended toward the terminal 31 of the coil unit 20b. Thereafter, the terminal 31 of the coil unit 22a is attached to the surface of the terminal 31 of the coil unit 20b by soldering or fusing to electrically connect the coil units 22a and 20b with each other.

Another coupled coil (not shown) having coil conductors 1 wound clockwise is produced in the same manner as the coupled coil 22. A field coil having these coupled coils is made round and inserted into the yoke 61 to manufacture a field apparatus.

Therefore, because a portion of a terminal 31 of one coil unit 22a acting as a crossover line and being connected with a terminal 31 of an adjacent coil unit 20b has a wider surface almost parallel to a coil surface 10 of the unit 22a, the portion of the terminal 31 acting as a crossover line can easily be bent in response to a pushing force directed in the second direction so as to be curved along a circumferential direction of a rounded field coil 5. Accordingly, when the portion of the terminal 31 is bent while making round a field coil, distortion or breakage generated in the coil units 22a and 20b or the connection points can be considerably reduced.

Further, because a crossover line is integrally formed with a coil unit by lengthening a coil conductor 1 of the coil unit, no connecting conductor acting as a crossover line is required. Therefore, the configuration of a field coil can be simplified. Further, because electrical attachment is required at a single connection point per a pair of coil units, productivity of a field apparatus can be improved.

In this embodiment, the rounded field coil 5 is formed in a cylindrical shape. However, the rounded field coil may be formed in a tubular shape so as to be inserted into a tubular yoke. Further, the number of coupled coils is not limited to two, and one or three coupled coils are, for example, allowed. The number of coil units in each coupled coil may be three or more. In this case, each pair of coil units are connected with each other through a connecting conductor. Each connecting conductor 4 may connect two coil units not adjacent to each other such that at least a current path is formed in a field coil. The conductor 1 is not limited to a straight angle shape and may be formed in an arbitrary shape such as a bar shape.

Based on these modifications, a field apparatus may comprise a tubular yoke and a field coil formed in a tubular shape and disposed on and fixed to an inner surface of the yoke. The field coil may have a plurality of coil units and a plurality of connecting conductors. The coil units are disposed in parallel to each other along a circumferential direction of the yoke. Each coil unit is made of a coil conductor. Each connecting conductor connects free terminals of the coil conductors of a pair of coil units to form a current path in the field coil. Each connecting conductor is curved along the circumferential direction of the yoke by bending the connecting conductor by a force added to the connecting conductor in a predetermined direction, and stiffness of the connecting conductor in the predetermined direction is lower than that of the coil conductor.

What is claimed is:

1. A field apparatus for a rotary electric machine, comprising:
a tubular yoke; and
a field coil formed in a tubular shape and disposed on and fixed to an inner surface of the yoke,
the field coil having
a plurality of coil units disposed in parallel to each other along a circumferential direction of the yoke, each of the coil units being made of a coil conductor; and
a connecting conductor connecting free terminals of the coil conductors of each pair of coil units to form a current path in the field coil,
wherein each connecting conductor is curved along the circumferential direction of the yoke by bending the connecting conductor, and stiffness of the connecting conductor is lower than that of the coil conductor.

2. The field apparatus according to claim 1, wherein a section modulus of each connecting conductor in the predetermined direction is almost one-fourth of a section modulus of the coil conductor in the predetermined direction.

3. The field apparatus according to claim 1, wherein each connecting conductor connecting two of the coil units is a portion of the coil conductor of one of the two coil units, and the free terminal of the coil conductor of the other one is connected with the portion of the coil conductor.

4. The field apparatus according to claim 3, wherein the coil conductor of the one coil unit is formed in a tape shape, and a wider surface of the portion of the coil conductor is almost parallel to a coil surface of the one coil unit, the coil surface facing the inner surface of the yoke.

5. The field apparatus according to claim 1, wherein the field coil has a plurality of coupled coils connected with each other in parallel, each coupled coil has two of the coil units or more, and the coil units of each coupled coil are connected with each other through the corresponding connecting conductor or conductors to form a current path.

6. The field apparatus according to claim 1, wherein the coil conductor of each coil unit is formed in a straight angle shape, the coil unit being made by winding up the coil conductor in a coil.

7. The field apparatus according to claim 1, wherein the yoke is formed in a cylindrical shape, and each coil unit is formed in a circular arc on a sectional surface of the yoke so as to form the field coil in the cylindrical shape.

8. The field apparatus according to claim 7, wherein each connecting conductors are placed on an inner side of the yoke with respect to the coil conductors.

9. The field apparatus according to claim 1, wherein the tubular field coil is obtained by rounding a substantially flat field coil while bending each connecting conductor in the predetermined direction.

10. The field apparatus according to claim 1, wherein each connecting conductor is curved by bending the connecting conductor by a force added to the connecting conductor in a predetermined direction, and stiffness of the connecting conductor in the predetermined direction is lower than that of the coil conductor.

11. The field apparatus according to claim 1, wherein the predetermined direction is a radial direction of the yoke.

12. A field coil for a field apparatus used for a rotary electric machine, comprising:
a plurality of coil units, each of the coil units being made of a coil conductor wound up in a coil, the coil units being disposed in parallel to each other along a first direction, each coil unit being formed in a circular arc on a predetermined plane defined by the first direction and a second direction perpendicular to the first direction; and
a connecting conductor through which two coil units in each pair are connected with each other,
wherein each connecting conductor extends along the first direction and is bendable so as to form a combination of the coil units in a cylindrical shape, and stiffness of each connecting conductor is lower than that of the coil conductor.
